(19) United States
(12) Patent Application Publication
(10) Pub. No.: US 2014/0035865 A1
(43) Pub. Date: Feb. 6, 2014

(54) MULTI-TOUCH ON SINGLE LAYER TOUCH SENSOR

(71) Applicant: Touchplus Information Corp., New Taipei City (TW)

(72) Inventor: Shih Hsien HU, New Taipei City (TW)

(73) Assignee: Touchplus Information Corp., New Taipei City (TW)

(21) Appl. No.: 13/895,333

(22) Filed: May 15, 2013

(30) Foreign Application Priority Data
Aug. 3, 2012 (TW) 101128094

(51) Int. Cl. G06F 3/044

(52) U.S. Cl. CPC G06F 3/044
USPC 345/174

(57) ABSTRACT

A touch panel, comprising: a substrate; first sensor elements separately positioned on the substrate, wherein each of some sensor elements of the first sensor elements is surrounded by six other nearby sensor elements with the edge-adjacent-to-edge arrangement; and connecting lines arranged on the substrate wherein each of the connecting lines is connected to a corresponding sensor element of the first sensor elements.

### CROSS-REFERENCE TO RELATED APPLICATION

This application claims the benefit of TAIWAN patent application no. 101128094, filed Aug. 3, 2012, which are herein incorporated by reference.

### TECHNICAL FIELD

The invention relates to the touch sensor and, in particular, to the single layer touch sensor.

### DESCRIPTION OF THE RELATED ART

Capacitive sensing is a technology based on capacitive coupling which takes human body capacitance as input. The capacitive touch sensor has been widely used in smart phones, tablets and even in the IT displays up to 23 inches, e.g. Notebooks, laptop trackpads, digital audio players, computer displays, ALL-in-one PCs, with the multi-touch features.

More and more design engineers are selecting capacitive sensors for their versatility, reliability and robustness, unique human-device interface and cost reduction over mechanical switches.

Capacitive sensors detect anything that is conductive or has a dielectric different than that of air. While capacitive sensing applications can replace mechanical buttons with capacitive alternatives, other technologies such as multi-touch and gesture-based touchscreens are also premised on capacitive sensing.

Capacitive sensors are constructed from many different media, such as copper, Indium Tin Oxide (ITO) and printed ink. Copper capacitive sensors can be implemented on Printing Circuit Boards (PCBs) as well as on flexible material. Indium Tin Oxide allows the capacitive sensor to be up to 90% transparent for one layer solutions, such as touch phone screens.

There are two types of capacitive sensing system: mutual capacitance, where the object (finger, conductive stylus) alters the mutual coupling between row and column electrodes, which are scanned sequentially; and self- or absolute capacitance where the object (such as a finger) loads the sensor or increases the parasitic capacitance to ground. In both cases, the difference of a preceding absolute position from the present absolute position yields the relative motion of the object or finger during that time.

FIGS. 1A and 1B show the structures of the traditional two-dimensional sensor arrays (1010, 1020). To have better coordination accuracy of the touched locations, the touch sensors often come with two-dimensional sensor arrays, including Double-sided Indium Tin Oxide (DITO) or Single-sided Indium Tin Oxide (SITO). The size of the sensor element from the sensor array is about the finger size (5-8 mm). The patterns of the sensor elements are mostly as the bar shape, the diamond shape or other polygon shape. For example, FIG. 1A shows that the pattern of the sensor elements (1018, 1016) in a two-dimensional sensor array 1010 is the bar shape and the two-dimensional sensor array 1010 includes a bottom layer 1012 and a top layer 1014, and FIG. 1B shows that the pattern of the sensor element 1022 in a two-dimensional sensor array 1020 is the diamond shape.

By referring to FIG. 1B, the connecting line “Xm” attaches to the m-th electrode in the horizontal axis, and the connecting line “Yn” attaches to the n-th electrode in the longitudinal axis. Thus, the trace routing for the two-dimensional sensor array 1020 whose number of traces is the number of electrodes in the horizontal axis plus the number of electrodes in the longitudinal axis, i.e., m+n, is easier than the one-dimensional sensor array.

FIGS. 2A and 2B show the structures of the traditional one-dimensional sensor arrays (2010, 2020). As the cost is concerned, especially the touch panel module takes a certain amount of total system cost, the one-dimensional sensor array came up, however, with the compromise of lower coordination accuracy. In order to have the multi-touch features on the one-dimensional sensor, the pattern design of sensor element becomes crucial. For example, FIG. 2A shows that the pattern of the sensor elements 2012 in a one-dimensional sensor array 2010 is the triangle shape, and FIG. 2B shows that the pattern of the sensor elements 2022 in a one-dimensional sensor array 2020 is the saw-tooth shape.

The sensor elements should be normally small while maintaining the touch accuracy or the resolution. This makes the trace routing difficult for the individual sensor element under the defined active area of the touch sensor. For example, FIG. 2B illustrates that the trace routing of the circuit 2024 for the individual sensor element 2022 is difficult under the defined active area of the one-dimensional sensor array 2020.

In general, the two-dimensional sensor array constructed as a matrix-like or keyboard-like structure has less constraint on the trace routing and provides much better touch accuracy comparing to the one-dimensional sensor array for multi-touch applications. The major drawback is the high cost in the manufacture.

On the other hand, one-dimensional sensor array is bounded by the routing space providing barely satisfied touch accuracy, but with the advantage from the cost. Under the limitation of touch accuracy, the size of one-dimensional sensor array for multi-touch is limited under 5 inches.

Currently, the capacitive touch panel with the sensor elements composed of a single material layer transmits signals from each sensor element by a separate connecting line, and determines the occurrence of the touch on the basis of the change of the singles from each sensor element directly. Thus, although the fabrication cost and working hours are reduced, it requires much more connecting lines to achieve the sensing accuracy, and results in difficulties on the design of wiring and connecting interface. On the other hand, when reducing the number of connecting lines, it will reduce the number of sensor elements and thus the sensing accuracy. Therefore, it is desirable to create a sensor array to resolve the above-mentioned issues.

### SUMMARY

The invention aims to resolve the above-mentioned issues. The invention provides the one-dimensional sensor array with multi-touch purpose.

The advantages of this invention includes: (1) the design for manufacture by resolving the routing issues; (2) the faster response time by reducing the number of sensor elements; (3) the improvement of the touch accuracy on one-dimensional sensor array; (4) the larger sensor elements with the higher touch accuracy; and (5) the reduction of the manufacture cost while maintaining the touch performance as 2-dimensional sensor array

The invention provides a touch panel, comprising: a substrate; first sensor elements separately positioned on the substrate, wherein at least one of the first sensor elements is surrounded by six other nearby first sensor elements with the edge-adjacent-to-edge arrangement; and connecting lines arranged on the substrate wherein each of the connecting lines is connected to a corresponding sensor element of the first sensor elements.

Alternatively, each of the first sensor elements is hexagonal or regular hexagonal.

The touch panel may further comprise second sensor elements whose shapes are halves of the first sensor elements, wherein the first sensor elements and the second sensor elements are arranged in a rectangular region, and the second sensor elements are adjacent to the edges of the rectangular region.

Alternatively, each of the first sensor elements has three pairs of opposite edges, and the opposite edges of each pair are parallel, distance between the opposite edges of one pair of the three pairs is 9 mm to 18 mm, and the three pairs have different distances between the opposite edges.

Further, the substrate may be a plastic substrate or glass substrate, and material of the first sensor elements is indium tin oxide, and the first sensor elements are arranged to form a honeycomb sensor array.

The touch panel may further comprise a cover lens positioned over the first sensor elements, and a control circuit positioned on a circuit board.

Alternatively, the circuit board may be Printing Circuit Board or Flexible Printing Circuit Board, each of the first sensor elements is smaller than two fingertips, and each of the first sensor elements is rectangular shape and surrounded by six sensor elements of the first sensor elements.

Alternatively, material of the connecting lines may be indium tin oxide, and material of the second sensor elements is indium tin oxide. Further, the first sensor elements, the connecting lines and the second sensor elements may be formed in the same processes.

Variation of capacitance value of the touch panel is resulted from fingertip or stylus contacting the touch panel, or variation of capacitance value of the touch panel is resulted from approaching of fingertip or stylus without the fingertip or the stylus contacting the touch panel.

### BRIEF DESCRIPTION OF THE DRAWINGS

The primitive objectives and advantages of the present invention will become apparent upon reading the following description and upon reference to the accompanying drawings in which:

FIGS. 1A and 1B show the structures of the traditional two-dimensional sensor arrays;

FIGS. 2A and 2B show the structures of the traditional one-dimensional sensor arrays;

FIG. 3 illustrates layers of a touch panel according to an embodiment of the invention;

FIG. 4A is a schematic diagram of an embodiment of the touch panel of the present invention;

FIGS. 4B˜4E illustrates how the touch panel of FIG. 4A determines the touched position;

FIG. 4F shows the hexagonal sensor elements with different sizes in different directions;

FIG. 5A illustrates the connecting structure of the triangle sensor elements 511˜514;

FIG. 5B illustrates the connecting structure of the square sensor elements 521˜525;

FIGS. 6A˜6D is a schematic diagram showing the sizes of the sensor elements and the size of the whole touch sensing area according to the four embodiments of the present invention; and

FIGS. 7˜9 are schematic views of sensor elements of the touch panels according to three additional embodiment of the present invention.

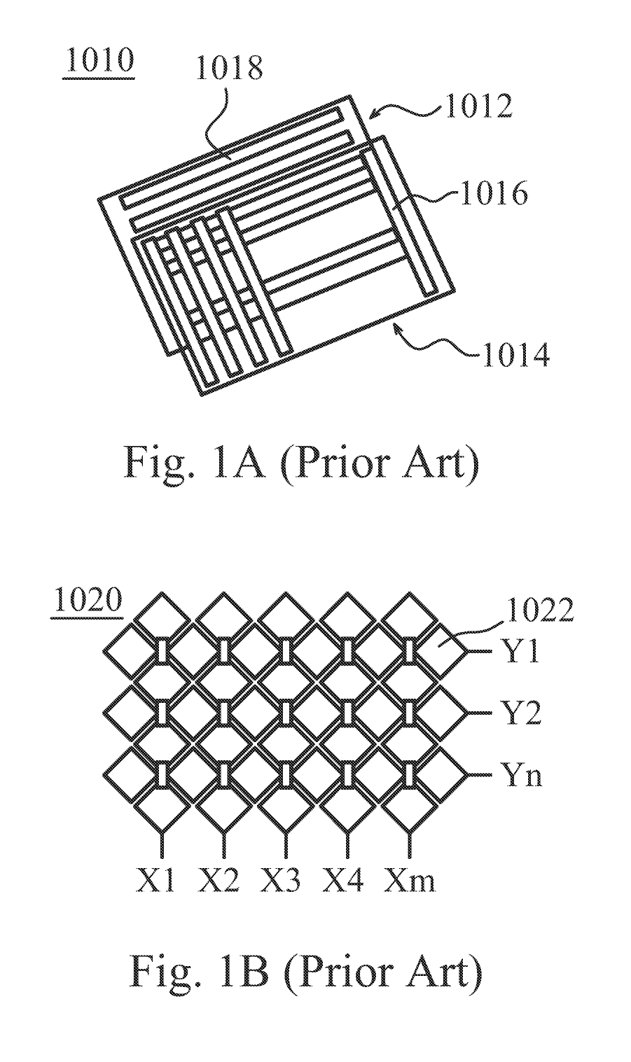

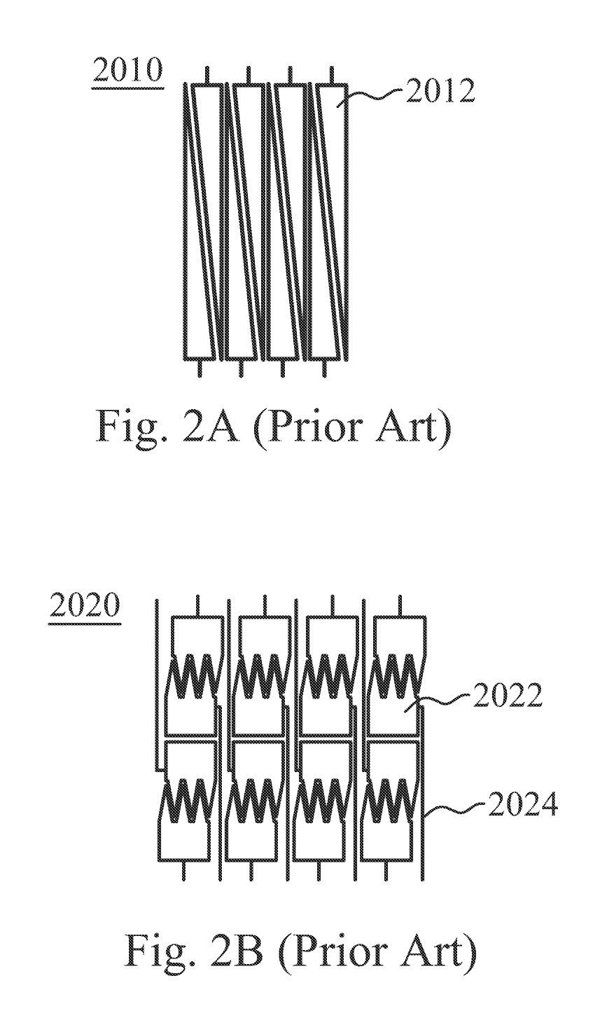

### DETAILED DESCRIPTION

In order to fully understand the manner in which the above-recited details and other advantages and objects according to the invention are obtained, a more detailed description of the invention will be rendered by reference to the best-contemplated mode and specific embodiments thereof. The following description of the invention is made for the purpose of illustrating the general principles of the invention and should not be taken in a limiting sense; it is intended to illustrate various embodiments of the invention. As such, the specific modifications discussed are not to be construed as limitations on the scope of the invention. It will be apparent to one skilled in the art that various equivalents, changes, and modifications may be made without departing from the scope of the invention, and it is understood that such equivalent embodiments are to be included herein. The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this detailed description section. Where the context permits, singular or plural terms may also include the plural or singular term, respectively. Moreover, unless the word “or” is expressly limited to mean only a single item exclusive from the other items in a list of two or more items, then the use of “or” in such a list is to be interpreted as including (a) any single item in the list, (b) all of the items in the list, or (c) any combination of items in the list.

Preferred embodiments and aspects of the invention will be described to explain the scope, structures and procedures of the invention. In addition to the preferred embodiments of the specification, the present invention can be widely applied in other embodiments.

The invention improves the one-dimensional sensor array, and optimizes the performance of the touch system with the overall considerations including the pattern design of one-dimensional sensor array and the driving scheme of the control circuit.

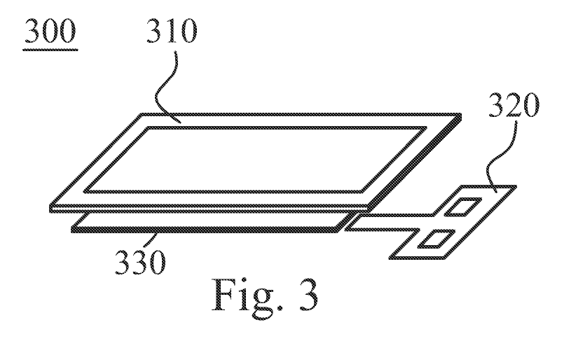

FIG. 3 illustrates layers of a touch panel according to an embodiment of the invention. The touch panel 300 comprises: a sensor array 330; a cover lens 310 positioned over the sensor array 330 for shielding the sensor array 330; and a control circuit 340 positioned on a circuit board 320, e.g., Printing Circuit Board (PCB) or Flexible Printing Circuit Board (FPC), and attached to the electrodes of the sensor array 330 with cables 342. The control circuit 340 can probe the touch signal on the sensor array 330 and report the touched coordination to the host system of the touch panel.

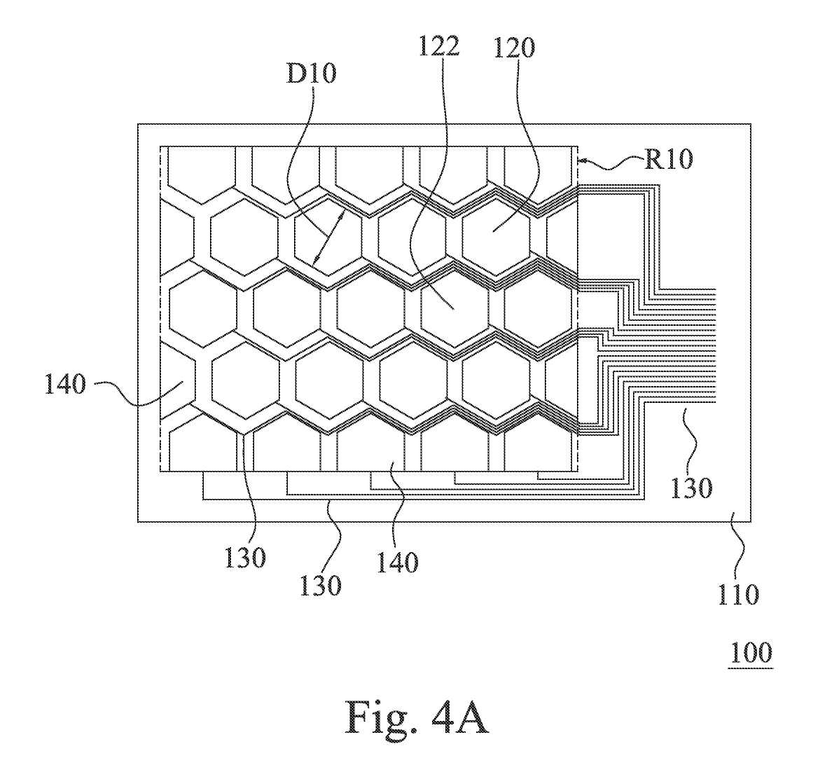

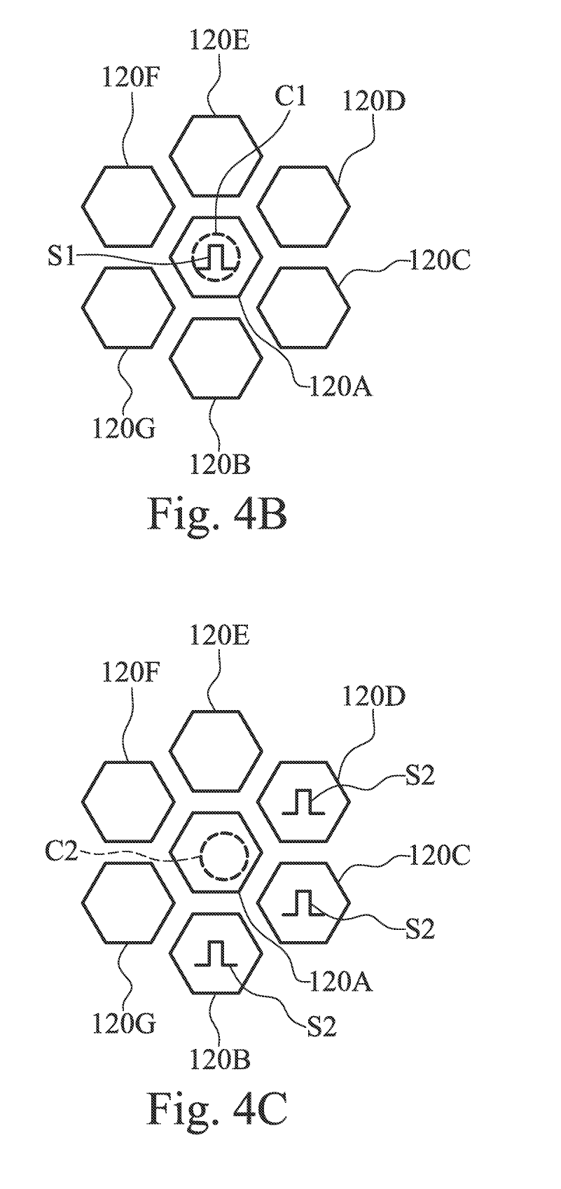

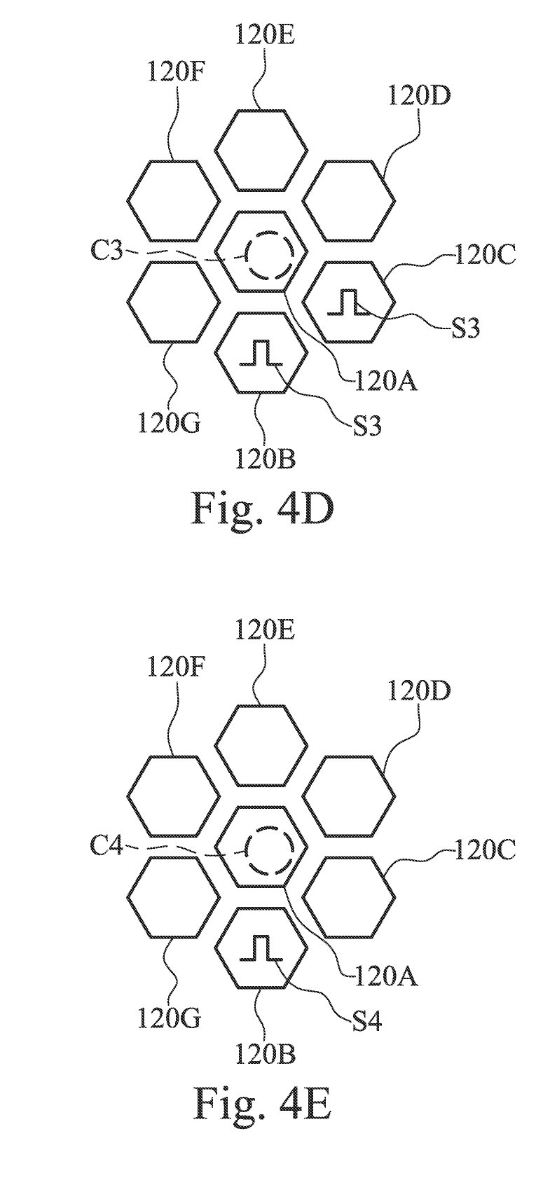

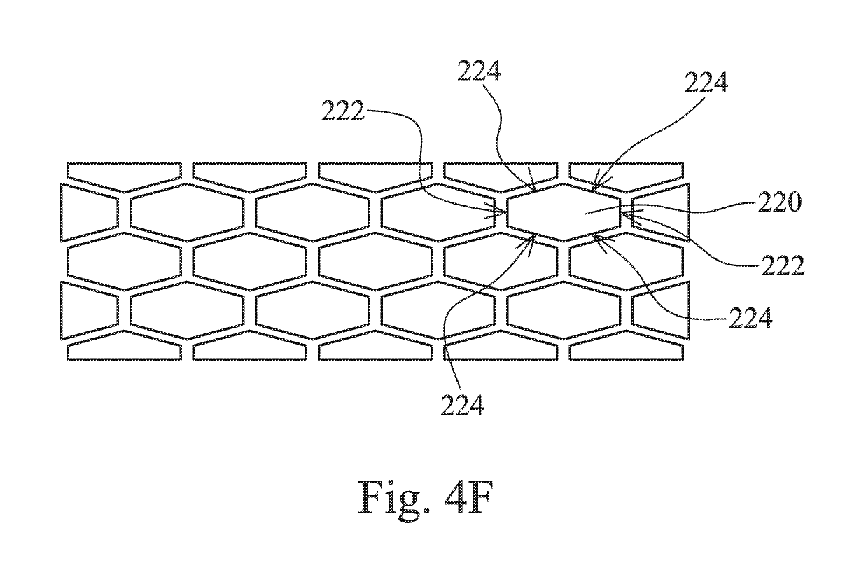

FIG. 4A is a schematic diagram of an embodiment of the touch panel of the present invention. The touch panel 100 of the present invention includes: a substrate 110, a plurality of first sensor elements 120, and a plurality of connecting lines 130. These first sensor elements 120 are arranged on the substrate 110, and each of the first sensor elements 120 are separated from each other and are electrically isolated. Each of some sensor elements of the first sensor elements 120 is surrounded by six other nearby first sensor elements 120, for example, the sensor element 122 shown in FIG. 4A. For example, a first sensor element 120 is surrounded by six first sensor elements 120. However, the first sensor element 120 at the edge of the substrate 110 may not be surrounded by six first sensor elements 120. The connecting line 130 is disposed on the substrate 110. Each connecting line 130 is connected to a corresponding one of the first sensor elements 120. And, each first sensor element 130 is connected to a corresponding connecting line 120.

FIGS. 4B˜4E illustrates how the touch panel of FIG. 4A determines the touched position. Please refer to FIG. 4B, the detecting signal S1 is sent to each of the first sensor elements 120A to 120G. Thus, if only the intensity of the signal returned from the first sensor element 120A is different from that returned from other sensor elements, it is determined that the first sensor element 120A is touched, shown in the circle C1. If multiple sensor elements return signal intensities different from other sensor elements and the above-mentioned steps cannot be used to confirm the touching position, the following steps can be chosen to carry out. By referring to FIG. 4C, the first sensor element 120A in the center sends three detecting signals S2 to the three adjacent sensor elements of the six first sensor elements 120B˜G surrounding the first sensor element 120A. When the signals returned from the first sensor elements 120B˜D possess the maximum intensities, it is determined that the touched position of the first sensor element 120A is the half close to the first sensor element 120B˜D, shown in the circle C2. By referring to FIG. 4D, the first sensor element 120A in the center sends two detecting signals S3 to the two adjacent sensor elements of the six first sensor elements 120B˜G surrounding the first sensor element 120A. When the signals returned from the first sensor elements 120B˜C possess the maximum intensities, it is determined that the touched position of the first sensor element 120A is the corner close to the first sensor element 120B˜C, shown in the circle C3. Further, by referring to FIG. 4E, the first sensor element 120A in the center sends one detecting signal S4 to a sensor element of the six first sensor elements 120B˜G surrounding the first sensor element 120A. When the signal returned from the first sensor elements 120B possesses the maximum intensity, it is determined that the touched position of the first sensor element 120A is the side close to the first sensor element 120B, shown in the circle C4.

It should be noted, the “touched” positions in the above-mentioned examples can be replaced by the “approached” position since the variation of the capacitance value of the capacitive touch panel can be resulted from the approaching of the user's fingertip or stylus without the user's fingertip or stylus contacting the capacitive touch panel. Therefore, the touch panel 100 of the present invention can not only detect the position where the charged object touches the touch panel 100, but also detect the position where the charged object approaches the touch panel 100.

Therefore, each of the first sensor elements 120 of the touch panel 100 in FIG. 4A is adjacent to up to six first sensor elements 120. Further, the capacitance between two adjacent one of the first sensor elements 120 is used to determine that the touched position occurs on a first sensor element 120, one side of a first sensor element 120, a corner of a first sensor element 120, a half of a first sensor element 120. Compared to the prior art which directly detect the touched position by each sensor element, the touch panel 100 of the present invention can achieve much higher detecting accuracy with the same number of sensor elements. On the other hand, in the same detecting area, the touch panel 100 of the present invention can use less number of sensor elements to achieve the same detecting accuracy as the conventional techniques. Therefore, the present invention can significantly reduce the number of connecting lines connected to the sensor elements, and makes the design of the wiring and connecting interface much easier.

The touch panel 100 of the present invention can integrate the capacitance values of two adjacent first sensor elements 120 to increase accuracy. Basically, the more adjacent first sensor elements 120 that each of the first sensor elements 120 has, the better the accuracy is. However, if the number of the adjacent sensor elements of each sensor elements is greater than six, these sensor elements cannot be arranged to form the symmetrical pattern. Therefore, the number “six” is chosen as the number of the first sensor elements 120 that are adjacent to each of the first sensor elements 120. In this case, the first sensor element 120 may be hexagonal, and, of course, circular or other shapes. The hexagonal first sensor element 120 has, for example, three pairs of opposite edges, edges of each pair are parallel to each other. The first sensor element 120 in the first embodiment of the present invention is regular hexagonal. However, to match the touching range required by the actual product, the sensor elements can be hexagonal with different sizes in different directions, similar to the shape of the regular hexagon compressed in a certain direction, for example, the sensor element 220 shown in FIG. 4F. The distances between the opposite edges of the three pairs are different. For example, the distance between a pair of opposite edges 222 is greater than the distance between each pair of opposite edges 224.

By referring to FIG. 4A, the distance D10 of each pair of opposite edges of the first sensor elements 120 is, for example, 9 mm to 18 mm. Specifically, the size of the first sensor elements 120 is smaller than the area that two fingertips occupy. Therefore, the touching of each fingertip can be exactly distinguished to achieve the purpose of detecting multi-touch.

The sensor element with the polygon shape has more adjacent edges to the neighbor sensor elements. That means more possibilities to have better accuracy of finger touch by stimulating the adjacent sensor elements. Therefore, a shape with more edges provides more touch signals from different adjacent sensor elements, and thus gets more precise results.

However, the ability of a shape to fill up an area by repeating the same shape is also required in terms of geometry. And the hexagonal shape has the most edges among the shapes that can be used to fill up an area by repeating the same shapes.

The combination of three, four and more sensor element may be used to indicate certain output signal. Therefore, the unit of the sensor configuration may provide multiple output signals to indicate different instructions.

For example, for each of the hexagonal sensor elements, the number of stimulus combinations from the adjacent sensor elements is:

P(6,6)+P(6,5)+P(6,4)+P(6,3)+P(6,2)+P(6,1)=1+6+15+20+15+6=63; it indicates that the present invention may provide multiple output signals by the sensing unit.

Because most common shapes to fill up the area symmetry are the triangles and the squares, the numbers of stimulus combinations in the triangle and square sensor elements are calculated in the below to prove that the number of stimulus combinations in the hexagonal sensor elements is larger than that in the triangle or square sensor elements.

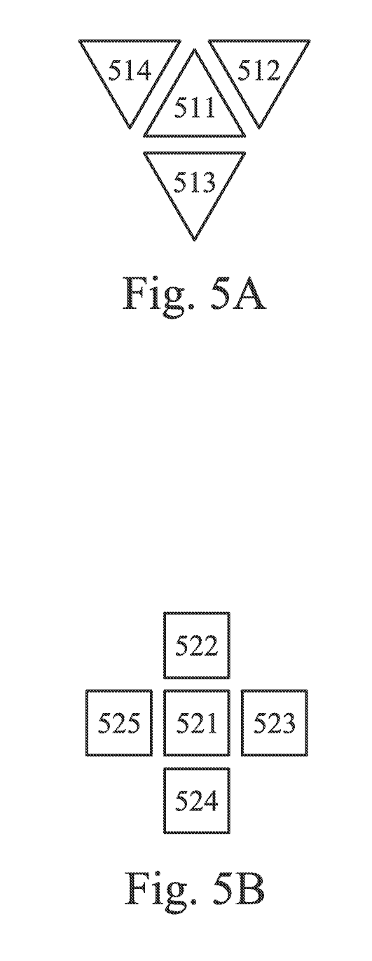

FIG. 5A illustrates the connecting structure of the triangle sensor elements 511˜514. For each of the triangle sensor elements, the number of stimulus combinations from the adjacent sensor elements is:

P(3,3)+P(3,2)+P(3,1)=1+3+3=7

FIG. 5B illustrates the connecting structure of the square sensor elements 521˜525. For each of the square sensor elements, the number of stimulus combinations from the adjacent sensor elements is:

P(4,4)+P(4,3)+P(4,2)+P(4,1)=1+4+6+4=15

Therefore, the number “63” of stimulus combinations in the hexagonal sensor elements is proved larger than the numbers “7” or “15” of stimulus combinations in the triangle or square sensor elements. To sum up, the hexagonal shape providing the most different kinds of stimulus should be the preferred shape for designing the sensor pattern.

Based on the hexagonal pattern of the sensor elements in the invention, different driving schemes can be created for getting better accuracy of the touched position. Once touched sensor element is located roughly, the “divide and conquer” algorithm is used.

To sum up, the touch panel of the invention can locate the different touched positions in a sensor element with high accuracy. Therefore, the sensor element of the invention could be larger than that of the traditional touch panel, and thus the routing traces can be reduced.

To support multi-touch, the sensor elements of the invention are arranged in a way to simulate the two-dimensional sensor array. Instead of the sensor array (electrodes), the sensor element is the fundamental unit on the touch sensor in the invention. And each sensor element of the invention has its own trace routed to the interface pad area on the same plane.

Here is an example to compare the routing traces between a two-dimensional sensor array and a one-dimensional sensor array. In a two-dimensional 7 inches ITO touch panel with 26 electrodes in the horizontal axis and 15 electrodes in the longitudinal axis:

If the touch panel is made of the two-dimensional sensor array, the touch panel may have the number of the routing traces:

26+15=41

But if the touch panel is made of the one-dimensional sensor array, the touch panel may have the number of the routing traces:

26*15=390

That is, to cover the same resolution as two-dimensional sensor array, the traditional one-dimensional sensor array needs 390 sensor elements and corresponding traces. The trace number may be more than 1000 if the panel size gets larger. In view of the manufacture, it is not feasible.

To reduce the routing traces, the most efficient way is to reduce the sensor elements on the touch sensor. To fill up the defined area of touch panel, e.g. 4.3, 5 or 7 inches of screen size, the size of the sensor element should be enlarged.

A touch sensor with different size of the sensor element will result different numbers of the sensor elements and the trace routings.

For example, a 4.3 inches touch sensor with the small sensor elements, each of which is width 1.0 cm and height 1.2 cm, has 66 sensor elements, and the same size touch sensor with the large sensor elements, each of which is width 1.5 cm and height 1.8 cm, has 32 sensor elements. Because the touch sensor with more sensor elements requires more trace routings, it is obvious that the touch sensor with small sensor elements needs more trace routings and is difficult to produce.

Therefore, the invention with the multi-touch features on the one-dimensional sensor array can use large sensor elements and require less trace routings while keeping the accuracy and response time of the touched fingers.

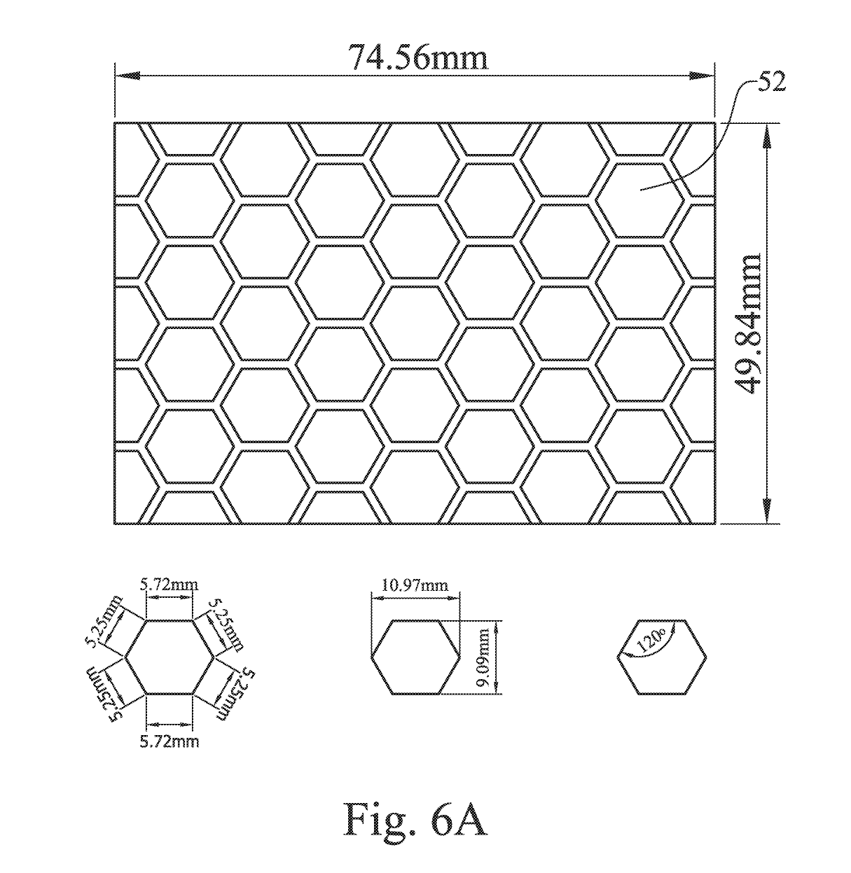

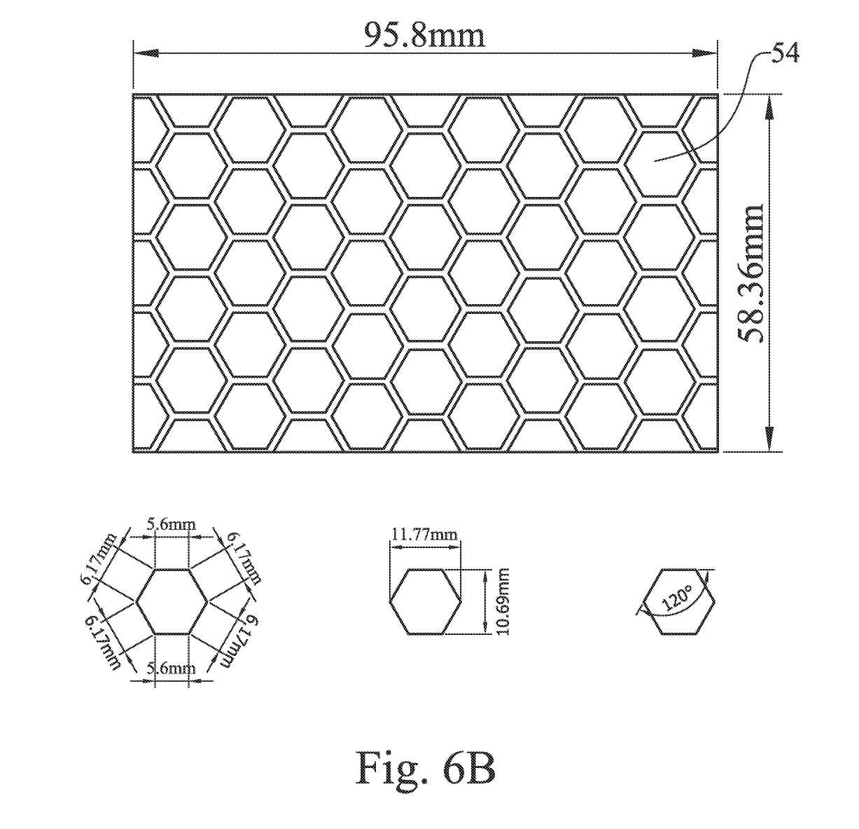

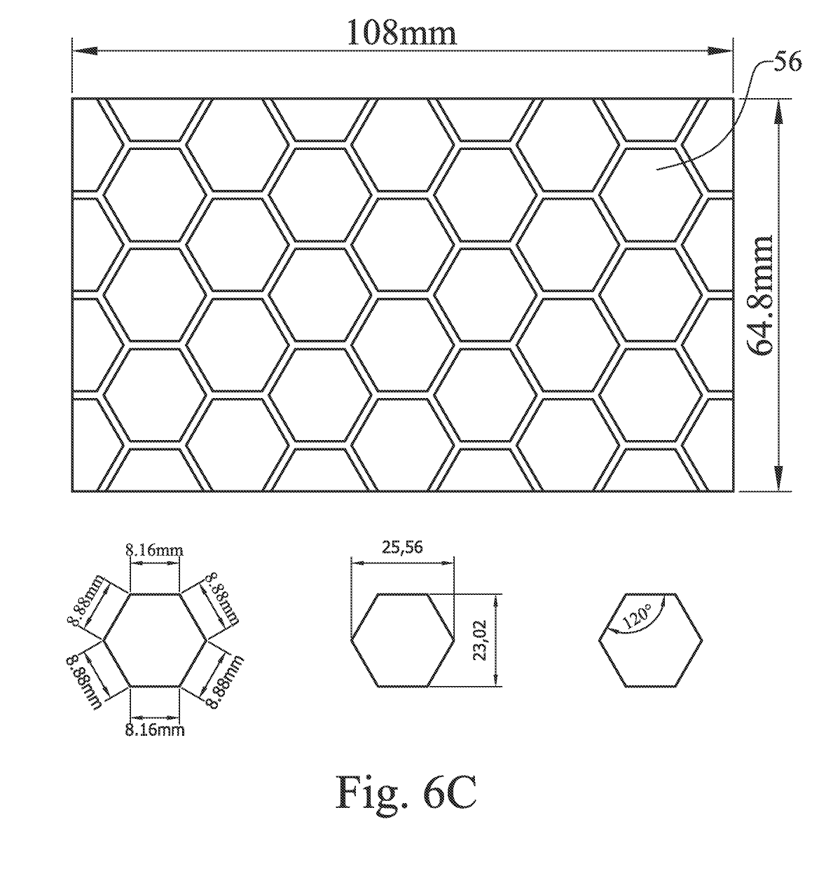

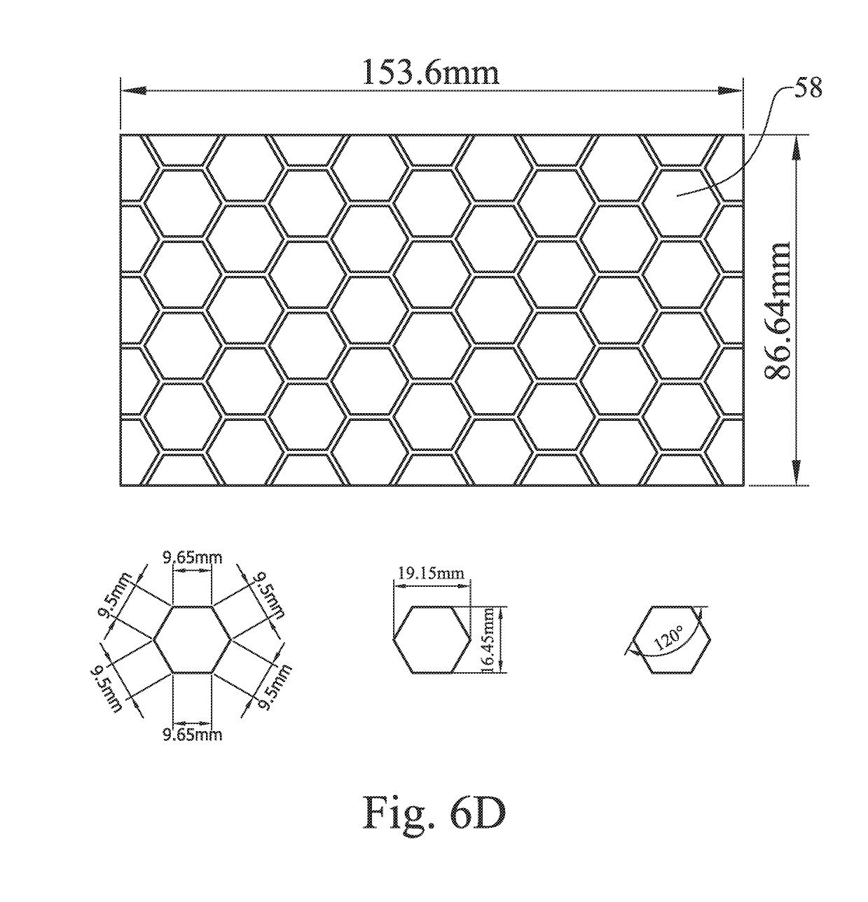

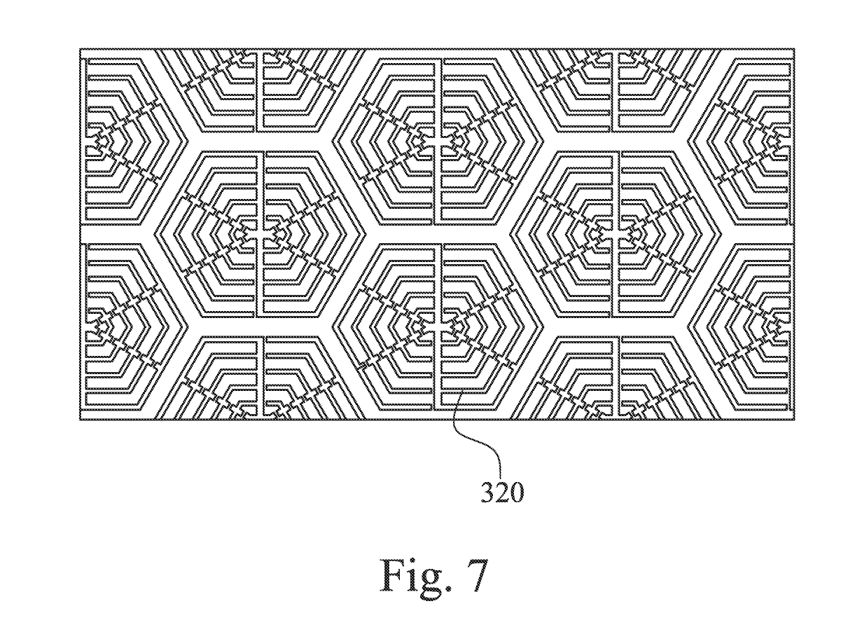

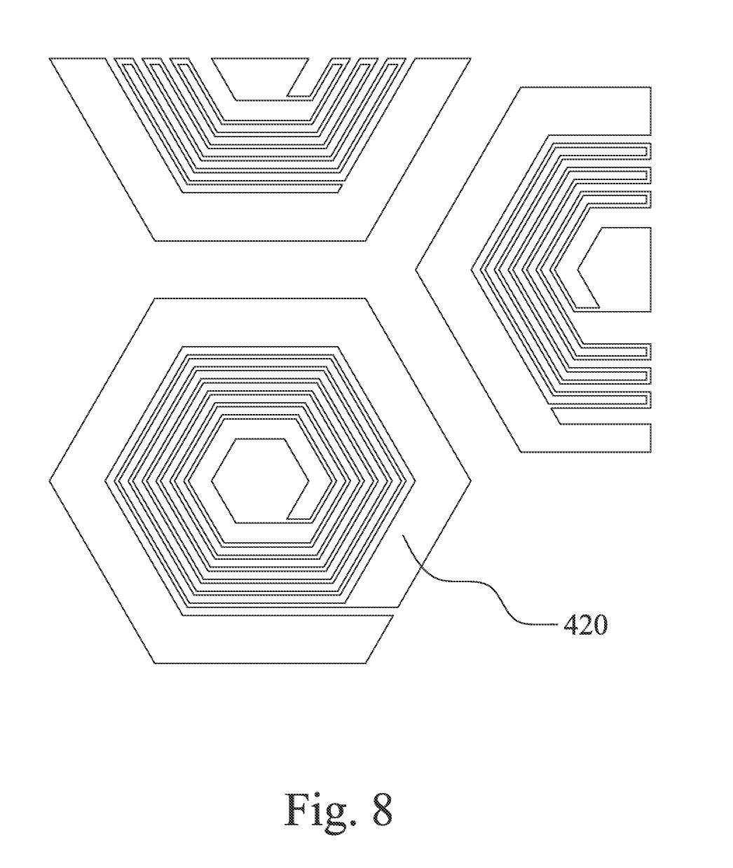

FIGS. 6A˜6D is a schematic diagram showing the sizes of the sensor elements and the size of the whole touch sensing area according to the four embodiments of the present invention. By referring to FIG. 5A, the touch panel with the 3.5 inch touch sensing region, i.e., with length and width within the range of 74.56 mm and 49.84 mm, can be configured to be covered by 49 sensor elements 52. Each angle of most of the sensor elements 52 is 120 degrees, and the minimum distance of one pair of opposite edges is 9.09 mm, and the maximum distance of two diagonal vertices is 10.97 mm, the lengths of the each edges are 5.72 mm and 5.25 mm. By referring to FIG. 6B, the touch panel with the 4.3 inch touch sensing region, i.e., with length and width within the range of 95.8 mm and 58.36 mm, can be configured to be covered by 60 sensor elements 54. Each angle of most of the sensor elements 54 is 120 degrees, and the minimum distance of one pair of opposite edges is 10.69 mm, and the maximum distance of two diagonal vertices is 11.77 mm, the lengths of the each edges are 5.6 mm and 6.17 mm. By referring to FIG. 6C, the touch panel with the 5 inch touch sensing region, i.e., with length and width within the range of 108 mm and 64.8 mm, can be configured to be covered by 40 sensor elements 56. Each angle of most of the sensor elements 56 is 120 degrees, and the minimum distance of one pair of opposite edges is 15.38 mm, and the maximum distance of two diagonal vertices is 17.04 mm, the lengths of the each edges are 8.16 mm and 8.88 mm. By referring to FIG. 6D, the touch panel with the 7 inch touch sensing region, i.e., with length and width within the range of 153.6 mm and 86.4 mm, can be configured to be covered by 60 sensor elements 58. Each angle of most of the sensor elements 58 is 120 degrees, and the minimum distance of one pair of opposite edges is 16.54 mm, and the maximum distance of two diagonal vertices is 19.15 mm, the lengths of the each edges are 9.65 mm and 9.5 mm.

In fact, the touch sensing area required by most electronic products are rectangular. Thus, the touch panel 100 of the present invention also has a rectangular region R10 for sensing touch. Further, to detect the touch in the entire rectangular region R10, the touch panel 100 may further include a plurality of second sensor elements 140. The first sensor elements 120 and the second sensor elements 140 may substantially cover the rectangular region R10, while the second sensor elements 140 are adjacent to the edge of the rectangular region R10. The shape of each of the second sensor elements 140 is a half of a sensor element 120. Such shape simplifies the arithmetic process of the returned sensing signals.

The substrate 110 may be a plastic substrate, a glass substrate, or other material. The materials of the first sensor elements 120, the connecting lines 130 and the second sensor elements 140 are electrically conductive materials, for example, the transparent conductive material, including indium tin oxide or other materials. The first sensor elements 120, the connecting lines 130 and the second sensor elements 140 may be formed in the same processes, including deposition, lithography and etching process, and benefit by the simple process and low cost.

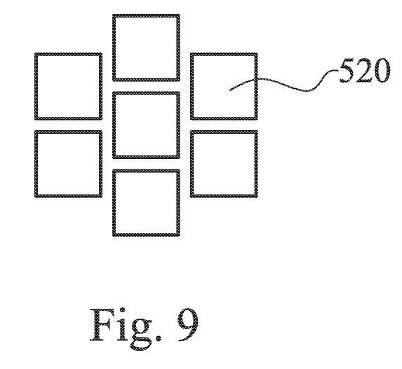

FIGS. 7˜9 are schematic views of sensor elements of the touch panels according to three additional embodiment of the present invention, wherein FIG. 8 and FIG. 9 only show a part of the sensor elements. By referring to FIG. 7 and FIG. 8, the sensor elements 320 and 420 are substantially hexagons with hollow portions. To optimize the touch sensing effect, one solution is to change the areas and shapes of the sensor elements 320 and 420. However, as long as each sensor element is surrounded by six sensor elements, the invention can achieved the aforementioned advantages of obtaining high sensing accuracy with the less sensor elements. For example, sensor elements with the snowflake or cyclic shapes may also be applied in the present invention. Alternatively, the sensor element 520 shown in FIG. 9 is rectangular shape, but still surrounded by six sensor elements 520.

In summary, the touch panel of the present invention detecting the signals from each sensor element surrounded by six sensor elements can obtain a higher sensing accuracy with less sensor elements, and thereby reduce the wiring design difficulties.

The foregoing description, for purposes of explanation, was set forth in specific details of the preferred embodiments to provide a thorough understanding of the invention. However, it will be apparent to one skilled in the art that specific details are not required in order to practice the invention. Therefore, the foregoing descriptions of specific embodiments of the invention are presented for purposes of illustration and description only and should not be construed in any way to limit the scope of the invention. They are not intended to be exhaustive or to limit the invention to the precise forms disclosed; obviously, many modifications and variations are possible in view of the above teachings. The embodiments were chosen and described in order to best explain the principles of the invention and its practical applications, thereby enabling others skilled in the art to best utilize the invention and various embodiments with various modifications as are suited to the particular use contemplated. It is intended that the following Claims and their equivalents define the scope of the invention.

The above-described embodiments of the present invention are intended to be illustrative only. Numerous alternative embodiments may be devised by those skilled in the art without departing from the scope of the following claims.

What is claimed is:

1. A touch panel, comprising:
a substrate;
first sensor elements separately positioned on the substrate, wherein at least one of the first sensor elements is surrounded by six other nearby first sensor elements with the edge-adjacent-to-edge arrangement; and
connecting lines arranged on the substrate wherein each of the connecting lines is connected to a corresponding sensor element of the first sensor elements.

2. The touch panel of claim 1, wherein each of the first sensor elements is hexagonal.

3. The touch panel of claim 2, wherein each of the first sensor elements is regular hexagonal.

4. The touch panel of claim 2, further comprising second sensor elements whose shapes are halves of the first sensor elements, wherein the first sensor elements and the second sensor elements are arranged in a rectangular region, and the second sensor elements are adjacent to the edges of the rectangular region.

5. The touch panel of claim 2, wherein each of the first sensor elements has three pairs of opposite edges, and the opposite edges of each pair are parallel.

6. The touch panel of claim 5, wherein distance between the opposite edges of one pair of the three pairs is 9 mm to 18 mm.

7. The touch panel of claim 5, wherein the three pairs have different distances between the opposite edges.

8. The touch panel of claim 1, wherein the substrate is a plastic substrate or glass substrate.

9. The touch panel of claim 1, wherein material of the first sensor elements is indium tin oxide.

10. The touch panel of claim 1, wherein the first sensor elements are arranged to form a honeycomb sensor array.

11. The touch panel of claim 1, further comprising a cover lens positioned over the first sensor elements.

12. The touch panel of claim 1, further comprising a control circuit positioned on a circuit board.

13. The touch panel of claim 12, wherein the circuit board is Printing Circuit Board or Flexible Printing Circuit Board.

14. The touch panel of claim 11, wherein each of the first sensor elements is smaller than two fingertips.

15. The touch panel of claim 1, wherein each of the first sensor elements is rectangular shape and surrounded by six sensor elements of the first sensor elements.

16. The touch panel of claim 1, wherein material of the connecting lines is indium tin oxide.

17. The touch panel of claim 4, wherein material of the second sensor elements is indium tin oxide.

18. The touch panel of claim 4, wherein the first sensor elements, the connecting lines and the second sensor elements are formed in the same processes.

19. The touch panel of claim 1, wherein variation of capacitance value of the touch panel is resulted from fingertip or stylus contacting the touch panel.

20. The touch panel of claim 1, wherein variation of capacitance value of the touch panel is resulted from approaching of fingertip or stylus without the fingertip or the stylus contacting the touch panel.
